(19) United States
(12) Patent Application Publication
(10) Pub. No.: US 2013/0219916 A1
(43) Pub. Date: Aug. 29, 2013

(54) APPARATUS AND METHOD FOR CONDITIONING AIR RECEIVED BY A POWER GENERATION SYSTEM

(71) Applicants: Bhachandra Arun Desai, Smyrna, GA (US); Huong Van Vu, Duluth, GA (US)

(72) Inventors: Bhachandra Arun Desai, Smyrna, GA (US); Huong Van Vu, Duluth, GA (US)

(73) Assignee: GENERAL ELECTRIC COMPANY, Schenectady, NY (US)

(21) Appl. No.: 13/404,866

(22) Filed: Feb. 24, 2012

(51) Int. Cl. F02C 6/08; F02C 9/16; F02C 7/08

(52) U.S. Cl. 60/782; 60/785; 60/39.093; 60/793; 60/736

(57) ABSTRACT

According to one aspect of the invention, a method for conditioning air received by a power generation system includes flowing ventilation air through a turbine system to control a temperature of the turbine system and receiving the ventilation air from the turbine system and mixing the ventilation with an ambient air to form an intake air to be directed to a compressor, wherein a temperature of the ventilation air is greater than the ambient air.

### BACKGROUND OF THE INVENTION

The subject matter disclosed herein relates generally to turbine engines. Specifically, the subject matter relates to an apparatus for conditioning air received by a gas turbine system.

Generally, power generation systems, such as gas turbine systems, are challenged by environmental conditions such as cold climates. Specifically, gas turbines receive cold air through a filter enclosure which is then directed to a compressor in the engine. Flow of cold air can cause ice to form on parts, such as the filters and the compressor. Accumulation of ice on the filters increases the pressure loss across the filter and can adversely affect turbine performance. Formation of ice on the compressor can lead to damage and downtime for repair or replacement of compressor parts.

### BRIEF DESCRIPTION OF THE INVENTION

According to one aspect of the invention, a method for conditioning air received by a power generation system includes receiving ventilation air in a turbine system to control a temperature of the turbine system and mixing the ventilation air from the turbine system with an ambient air to form an intake air to be directed to a compressor, wherein the ventilation air increases the temperature of the intake air.

According to another aspect of the invention, a power generation system includes a compressor in fluid communication with an air inlet and a turbine system in fluid communication with the compressor, wherein a ventilation air flows through the turbine system to control a temperature of the turbine system. The system also includes a passage configured to direct the ventilation air from the turbine system and mix the ventilation air with an ambient air to form intake air to be received by the air inlet, wherein a temperature of the ventilation air is greater than a temperature of the ambient air.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an embodiment of a power generation system that includes an air conditioning system;

FIG. 2 is a diagram of a portion of an embodiment of a power generation system; and

FIG. 3 is a diagram of a portion of another embodiment of a power generation system.

The detailed description explains embodiments of the invention, together with advantages and features, by way of example with reference to the drawings.

### DETAILED DESCRIPTION OF THE INVENTION

As used herein the term controller or control module refers to an application specific integrated circuit (ASIC), an electronic circuit, a processor (shared, dedicated or group) and memory that executes one or more software or firmware programs, a combinational logic circuit, and/or other suitable components that provide the described functionality.

In addition, as used herein, “downstream” and “upstream” are terms that indicate a direction relative to the flow of working fluid through the turbine. As such, the term “downstream” refers to a direction that generally corresponds to the direction of the flow of working fluid, and the term “upstream” generally refers to the direction that is opposite of the direction of flow of working fluid. The term “radial” refers to movement or position perpendicular to an axis or center line. It may be useful to describe parts that are at differing radial positions with regard to an axis. In this case, if a first component resides closer to the axis than a second component, it may be stated herein that the first component is “radially inward” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. Although the following discussion primarily focuses on gas turbines, the concepts discussed are not limited to gas turbines.

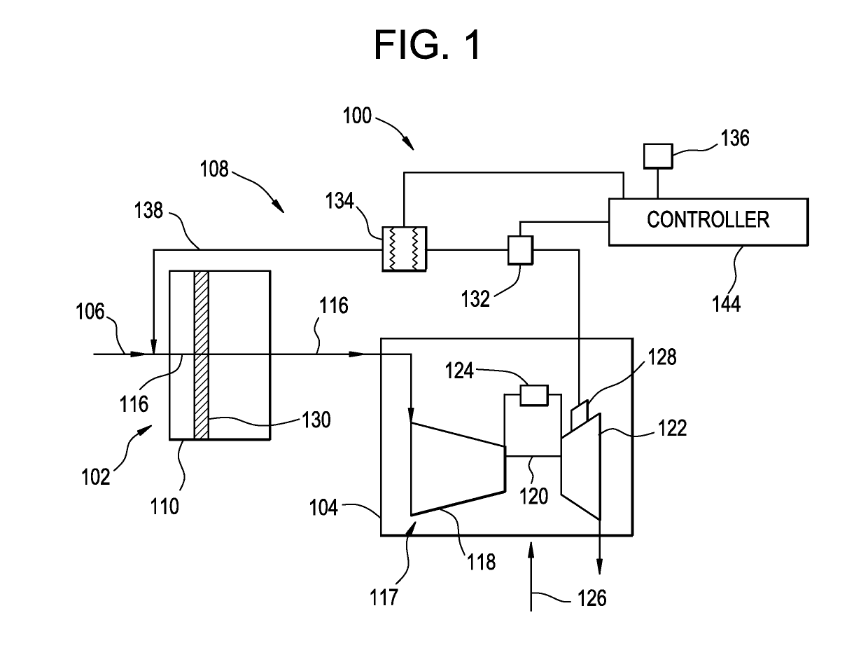

FIG. 1 shows a schematic diagram of an embodiment of a power generation system 100 used to generate an electrical and/or mechanical power output. The power generation system 100 (also referred to as “turbine system”) includes a filter system 102 and turbine compartment 104. The filter system 102 is configured to filter an ambient air 106 received by the turbine compartment 104. As depicted, the filter system 102 includes an air conditioning system 108 to condition the air. The ambient air 106 is received by a filter housing 110 that includes a filter 130 to remove particles and impurities from the ambient air 106 to provide an intake air 116 (also referred to as “input air”) for a turbine engine 117. The turbine engine 117 includes a compressor 118, a shaft 120, a turbine 122 and a combustor 124. In an embodiment, the turbine engine 117 may include a plurality of compressors 118, combustors 124, turbines 122 and shafts 120. As depicted, the compressor 118 and turbine 122 are coupled by the shaft 120.

In an aspect, the combustor 124 uses liquid and/or gas fuel, such as natural gas or a hydrogen rich synthetic gas, to run the turbine engine. For example, fuel nozzles located in the combustor 124 are in fluid communication with a fuel supply and pressurized air provided by the compressor 118. The compressor 118 receives intake air 116, wherein the compressor blades or vanes turn to compress the air that is then directed to the fuel nozzles. The fuel nozzles create an air-fuel mix, and discharge the air-fuel mix into the combustor 124, thereby causing a combustion that creates a hot pressurized gas. The combustor 124 directs the hot pressurized gas into a turbine nozzle (or “stage one nozzle”), causing turbine 122 rotation as the hot gas flows across vanes in the nozzle. The rotation of turbine 122 causes the shaft 120 to rotate, thereby compressing the air as it flows into the compressor 118. Rotation of the shaft 120 further provides a rotational mechanical power output, which may be used to generate electricity.

As depicted, the air conditioning system 108 adds a ventilation air 138 to the ambient air 106 to form the intake air 116. In an embodiment, an ambient air 126 is received in the turbine 122 and used to control a temperature of parts of the turbine system, such as a turbine casing 128, where the ventilation air 138 comprises the ambient air flow 126 after heating as it flows through the turbine 122. Specifically, in one embodiment, the ambient air 126 is heated as it flows through walls of the turbine casing 128 to provide cooling for the part, where the ventilation air 138 is the heated air received by the air conditioning system 108 from the turbine 122. Accordingly, the ventilation air 138 has a relatively higher temperature than the ambient air 106 and, thus, can cause an increase in the intake air 116 temperature. In embodiments, the ventilation air 138 flows through parts for cooling, wherein the parts are heated by the air/fuel combustion and flow of exhaust gas through the parts. For example, the ventilation air 138 flows through passages in walls of selected turbine parts, such as a turbine casing, to provide cooling for the parts. In an embodiment, the ventilation air 138 is received from outside the turbine engine as ambient air and is heated as it cools selected turbine parts. By adding the ventilation air 138 to the ambient air 106, the system controls the temperature of the intake air 116 received by the filter 130 and compressor 118.

In one embodiment, the air conditioning system 108 includes a valve 132 and temperature sensor 136 coupled to a controller 144. The controller 144 and temperature sensor 136 are configured to determine temperature of ambient air 106 which is used to determine the amount of ventilation air 138 to flow through valve 132 and added to ambient air 106 to result in a desired temperature for intake air 116. In addition, an embodiment includes a heating element 134 coupled to the controller 144, where the heating element may be used to further heat the ventilation air 138 to cause the intake air 116 to increase to the desired temperature. The heating element 134 may be any suitable heating device for transferring heat to a flowing fluid, such as electric coils.

Embodiments of the air conditioning system 108 are used to control the temperature of the intake air 116. In one embodiment, the air conditioning system 108 combines the ventilation air 138 with ambient air 106 to form the intake air 116 with an increases intake air temperature to reduce buildup of ice in the filter 130 and/or compressor 118. Ice accumulation on the filter 130 can cause a pressure drop in the intake air 116 flow, which can affect turbine efficiency. In addition, ice accumulation in the compressor 118 can cause part damage, associated costs and downtime for repair or replacement. Embodiments improve turbine performance and reduce costs, especially in colder climates. Heating the intake air 116 by using ventilation air 138 reuses waste heat from the power generation system 100, where it improves efficiency as compared to systems that use coils or other heating devices as the primary source for heating intake air 116. Further, ventilation air 138 being mixed with the ambient air 106 prior to flowing into the filter 130 provides relatively clean air, thus improving filter life. For example, in cases where exhaust gas is mixed with the ambient air 106 prior to flowing into the filter 130, the relatively dirty exhaust requires cleaning by the filter, thus shortening filter life. Further, buildup of particulates in the filter 130 may also cause an unwanted pressure drop across the filter 130. In addition, exhaust gas added to intake air 116 may cause shortened life for compressor blades. Thus, the ventilation air 138 is cleaner (i.e., requires less filtering) than exhaust gas, which can improve filter life. In addition, embodiments of the air conditioning system 108 increase the temperature and reduce density of intake air 116 to reduce the power output of the power generation system 100. This is desirable at low load conditions, where it is desirable to continue running the turbine engine 117 when power output needs are low. Low load conditions may occur during off peak hours, where power needs are low and it is inefficient to shut down and restart the turbine engine 117 when power needs later increase.

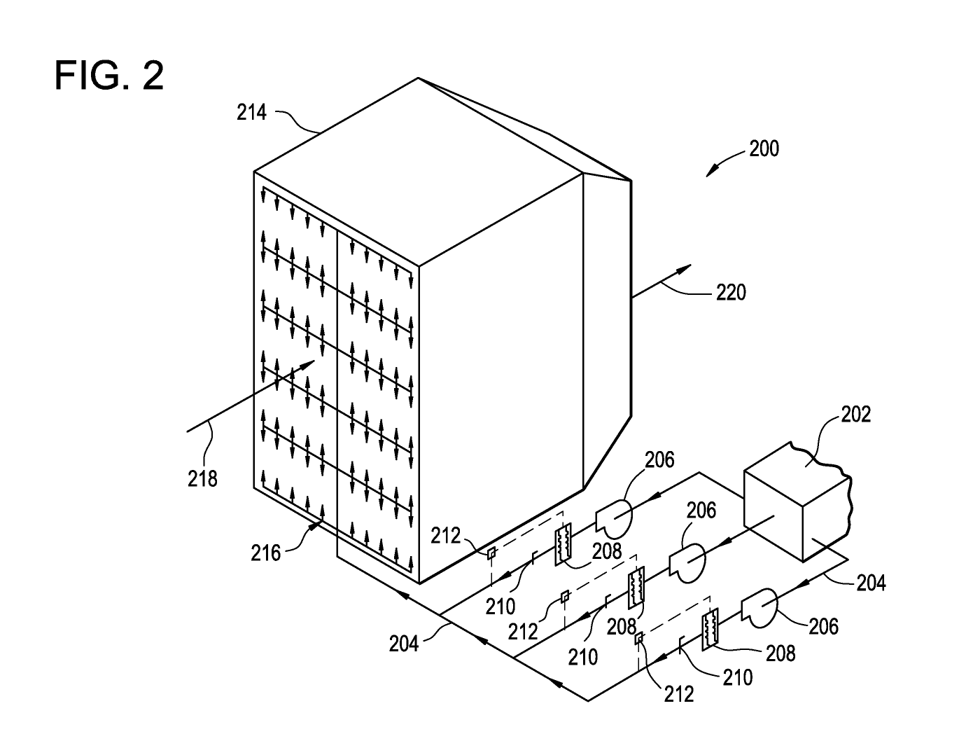

FIG. 2 is a diagram of a portion of an embodiment of a power generation system 200. The power generation system 200 includes a ventilation duct 202 that provides ventilation air 204 from a turbine (not shown). In an embodiment, the ventilation duct 202 may be insulated to maintain a temperature of the ventilation air 204 within the duct. As depicted, the ventilation air 204 is split into a plurality of flowpaths, where each flow path includes an air forwarding device, such as a fan 206, a heating element 208, a valve 210 and a controller 212. Embodiments may have a single controller, a plurality of controllers in communication with one another or a plurality of independent controllers. The controller 212 is configured to control air temperature via the heating element 208 and flow pressure via the fan 206. The controller 212 and valve 210 are configured to control the flow of ventilation air 204 to a housing 214. In an embodiment, the housing 214 is positioned upstream of a turbine engine compressor (not shown) and may include a filter. The power generation system 200 has a distribution system 216 to distribute the ventilation air 204 within an ambient air 218 flowing into or within the filter housing 214. In an embodiment, the distribution system 216 includes a plurality of horizontal and vertical conduits with outlets or passages to distribute the ventilation air 204. The ventilation air 204 is distributed and combined with the ambient air 218 to form an intake air 220 that is received by a compressor (not shown). In an embodiment, the ventilation air 204 is heated as it flows through walls of turbine components, such as the turbine casing, to cool the components. The heated ventilation air 204 enters the ventilation duct 202 from the turbine and is combined with the intake air 218 to increase the temperature of the intake air 220.

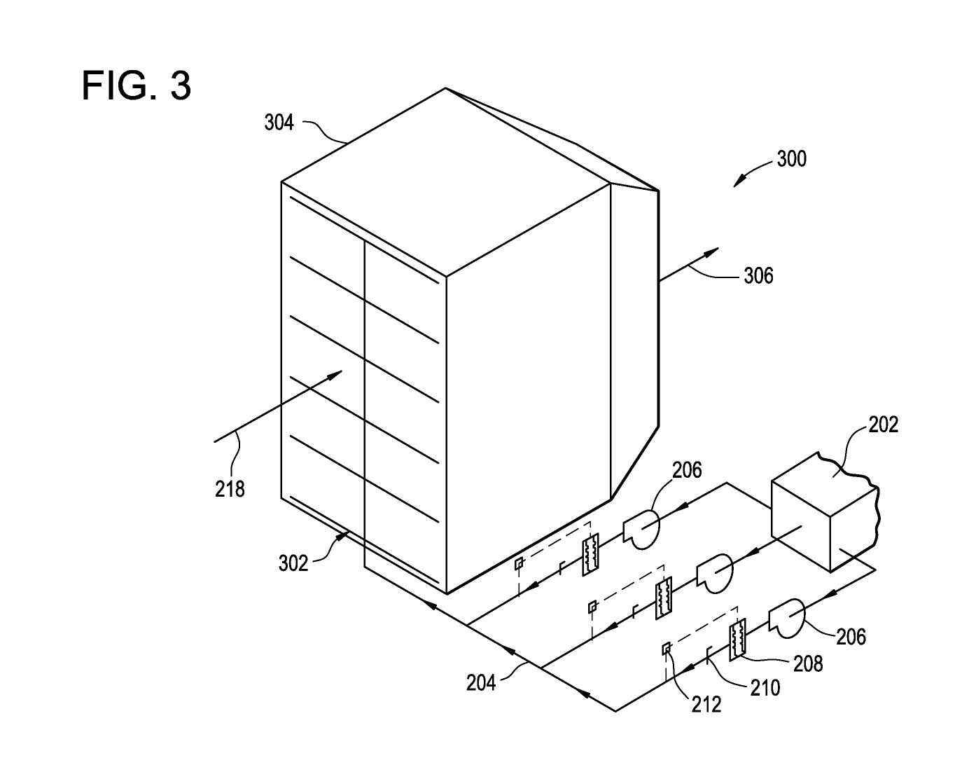

FIG. 3 is a diagram of a portion of another embodiment of a power generation system 300. In an embodiment, the power generation system 300 receives the ventilation air 204 from the compressor to heat the ambient air 218 received by a housing 304. A heat exchange system 302 includes coils or pipes that receive the heated ventilation air 204, where the ambient air 218 is heated as it flows over the heated coils. Accordingly, an intake air 306 flows from the housing 304, wherein the intake air 306 has been heated by ambient air 218 flowing across the heat exchange system 302.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for conditioning air received by a power generation system, the method comprising:
flowing ventilation air through a turbine system to control a temperature of the turbine system; and
receiving the ventilation air from the turbine system and mixing the ventilation air with an ambient air to form an intake air to be directed to a compressor, wherein a temperature of the ventilation air is greater than the ambient air.

2. The method of claim 1, wherein the intake air is received by the compressor after flowing through a filter in a filter housing upstream of the compressor.

3. The method of claim 1, wherein flowing the ventilation air through the turbine system comprises heating the ventilation air as it flows through a casing of the turbine system, thereby cooling the casing.

4. The method of claim 1, comprising controlling a flow rate and temperature of the ventilation air from the turbine system to be mixed with the ambient air.

5. The method of claim 4, wherein controlling comprises controlling the flow rate and temperature based on a sensed ambient air temperature.

6. The method of claim 1, comprising heating the ventilation air prior to mixing with the ambient air via a heating device.

7. The method of claim 1, wherein the ventilation air is mixed with the ambient air to heat the intake air and reduce formation of ice in a filter or in the compressor.

8. The method of claim 1, wherein the ventilation air is mixed with the ambient air to reduce a density of the intake air to produce less power at a low load condition for the power generation system.

9. A power generation system, comprising:
a compressor in fluid communication with an air inlet;
a turbine system in fluid communication with the compressor, wherein a ventilation air flows through the turbine system to control a temperature of the turbine system; and
a passage configured to direct the ventilation air from the turbine system and mix the ventilation air with an ambient air to form intake air to be received by the air inlet, wherein a temperature of the ventilation air is greater than a temperature of the ambient air.

10. The system of claim 9, wherein the air inlet comprises a filter housing that includes a filter.

11. The system of claim 9, wherein the ventilation air is heated as it flows through a casing of the turbine system.

12. The system of claim 9, comprising a controller and a valve configured to control flow of the ventilation air through the passage.

13. The system of claim 12, comprising a temperature sensor coupled to the controller configured to determine an ambient air temperature that is used to control the flow of ventilation air to mix with the ambient air.

14. The system of claim 9, comprising a heating device configured to heat the ventilation air prior to mixing with the ambient air.

15. The system of claim 9, wherein the ventilation air is mixed with the ambient air to increase the temperature of the intake air and reduce formation of ice in a filter in the air inlet or in the compressor.

16. The system of claim 9, wherein the ventilation air is mixed with the ambient air to reduce a density of the intake air to produce less power at a low load condition for the power generation system.

17. An apparatus for conditioning air, comprising:
a filter housing;
a compressor in fluid communication with the filter housing;
a turbine system coupled to the compressor, wherein a ventilation air flows through the turbine system to cool the turbine system;
a passage configured to direct the ventilation air from the turbine system to the filter housing, wherein a temperature of the ventilation air is greater than a temperature of an ambient air;
an air forwarding device in the passage configured to direct ventilation air to the filter housing; and
a flow control device to control an amount of ventilation air flowing to the filter housing.

18. The apparatus of claim 17, wherein the passage directs the ventilation air from the turbine to be added to the ambient air to form intake air that is received by the housing.

19. The apparatus of claim 17, wherein the passage directs the ventilation air from the turbine system to a heat exchange system that the ambient air flows across.

20. The apparatus of claim 17, wherein the ventilation air is mixed with the ambient air to increase the temperature of an intake air received by the compressor and to reduce formation of ice in the compressor or in a filter in the filter housing.
